(19) United States
(12) Patent Application Publication
(10) Pub. No.: US 2008/0257872 A1
(43) Pub. Date: Oct. 23, 2008

(54) LASER CUTTING METHOD

(75) Inventor: Peter Muys, Gent (BE)

Correspondence Address: KNOBBE MARTENS OLSON & BEAR LLP, 2040 MAIN STREET, FOURTEENTH FLOOR, IRVINE, CA, 92614, US

(73) Assignee: LAMBDA RESEARCH OPTICS EUROPE, Nazareth-Eke (BE)

(21) Appl. No.: 12/127,721

(22) Filed: May 27, 2008

Related U.S. Application Data
(63) Continuation-in-part of application No. PCT/EP2006/067806, filed on Oct. 26, 2006.

(30) Foreign Application Priority Data
Nov. 25, 2005 (EP) 05111335.5

(51) Int. Cl. B23K 26/14

(52) U.S. Cl. 219/121.67

(57) ABSTRACT

Laser cutting method using a CO₂ laser light beam focalized by means of a ZnSe-lens system, which involves a laser beam power above 4 kW, using radially or azimuthally polarized laser light.

### CROSS-REFERENCE TO RELATED APPLICATIONS

This application is a continuation-in-part of International Application Number PCT/EP2006/067806, filed Oct. 26, 2006, which claims the benefit of priority to EP Application Number EP05111335.5, filed Nov. 25, 2005.

### BACKGROUND OF THE INVENTION

1. Field of the Invention

The present invention relates to a method for cutting metals and other materials, such as in particular steel plates, using a cutting tool involving a focalized high power laser light beam.

2. Description of the Related Art

A particular class of cutting machines or cutting tools of this type specifically involves the use of so called CO₂ laser beams, emitting at 10.6 micrometer wavelength. Over the last ten years, the cutting of steel plates using CO₂ laser light has developed into an important and mature technology.

The cutting action is realized by focusing the laser light on the plate surface. Since the plate will absorb the radiation, the material will rise in temperature and finally will melt. The better the light concentration is on the plate surface, the higher the cutting speed can be. This laser light concentration is realized by focalizing the laser beam. An incident (nearly) parallel laser beam is transformed into a convergent beam where the zone of convergence is positioned at or near the plate surface. The longitudinal (along the beam propagation axis) and transversal extent of this focused zone will determine the degree of concentration of the laser light onto the plate surface. On its turn, this will determine the cutting speed. From this argument, it is clear that the cutting speed is determined (among other parameters) by the focused spot concentration, by the incident laser power and by the plate absorption.

### SUMMARY OF THE INVENTION

Some embodiments are directed to laser cutting methods using a CO₂ laser light beam focalized by means of a ZnSe-lens system. In some aspects, radially polarized laser light is applied. In other aspects, azimuthally polarized laser light is applied. In some aspects, a laser power between 4-6 kW is applied. In other aspects, a laser power above 6 kW is applied.

### DETAILED DESCRIPTION

Focalizing CO₂ laser beams can be achieved by means of lenses (refractive optics), in particular Zinc Selenide lenses, or by means of mirrors (reflective optics). Since machines aimed to the cutting of steel plates are capital intensive, there is a continuous demand to upgrade their productivity.

More specifically, for upgrading the productivity of such high power laser cutting machines, higher cutting speeds have to be used so that more plates can be cut per hour and therefore the laser power has to increase.

There is therefore an ongoing trend in the cutting tool industry to increase the power of the laser sources, so as to increase the productivity of such expensive cutting machines.

In a relatively short period cutting tool laser sources have evolved from the “high power” sources (using laser beams of 2-4 kW) to “very high power” sources (using laser beams of 4-6 kW).

One can in this respect for instance refer to the articles “cutting with a carbon dioxide laser,” published in 2000 by P. Hilton as TWI Knowledge Summary (disclosing 1-1.5 kW as standard power), and “high-power CO₂ laser design” published by D. Toebaert & W. Wagenaar in Journal of Laser applications, May 2004, vol 16, no 2, pp. 100-110 (disclosing 4 kW as standard power), to illustrate this trend. Since the reliability of the ZnSe lenses decreases with increasing power, many manufacturers switch from lenses (refractive optics) to mirrors (reflective optics) once they have to work with powers above 4 kW. Mirrors can be much better cooled than lenses, they do not deform and are robust. Lenses are fragile and sensitive to thermal shock. Reference can be made in this respect to the disclosure, at pp. 61-63 of Laser Materials Processing, edited by L. Migliore in 1989 (ISBN 0-8247-9714-0), discussing the transition from refractive to reflective optics at 2 kW, to the article “Optical distortion of transmissive optics at high power CO₂ laser irradiation” by H. Takahashi, M. Kimura and R. Sano in Applied Optics, vol. 28, no 9, May 1989, pp. 1727-1730, disclosing the deformation of a ZnSe lens at 1050 W. and to the article “thick section cutting” by D. Petring, AILU Technology Workshop, Leicestershire, February 2001, disclosing a cutting head for applications >3 kW based on a mirror.

The disadvantage of using mirrors however is not from an optical constraint but from the cutting process itself. Either you use a lens or a mirror to focus the radiation, you always need an assist gas which streams coaxial with the laser beam, in order to blow out the molten material from the kerf. In a cutting head, the lens is installed together with a small nozzle which is located close to its focusing spot. The lens, lens housing and nozzle form a kind of Laval pipe: at the focal spot of the lens we will also have a high speed, high pressure gas beam. This is not possible when a mirror is used to focus the laser light. The mirror is used under 45 degrees of angle of incidence and cannot form a closed vessel with the nozzle, so that no gas pressure can be built up. Hence, it is only when you are really forced to switch to mirrors, that you actually will do it since you now run into a lot of mechanical problems to blow out the molten material.

As described in EP 0365511, herein incorporated by reference in its entirety, it is known that the lens of a high power laser cutting machine has the property of transmitting a known percentage (in the order of 99% or more) of the laser light generated in a laser tube and reflecting or absorbing the remaining percentage. The lens must not degrade the beam characteristics by deforming under the influence of the high power laser radiation. However, it is unavoidable for the lens to absorb a part of the transmitted light. This absorbed laser light heats up the lens and causes expansion and thermal stresses.

In one embodiment, zinc selenide is used exclusively as raw material for the lens substrates. In some embodiments, the appropriate anti-reflex coatings on the lens surfaces make the lens transmission routinely higher than 99.7%. In such embodiments, the remaining portion (0.30%) constitutes the residual absorption of the lens and will appear as heat in the lens body. This heat, typically 10 to 30 Watts in some embodiments, leads to a number of thermal effects which are disadvantageous for the lens focusing capabilities, although the absorption of less than 0.30% might seem to be considered as negligible.

Chemical vapor deposited ZnSe (CVD-ZnSe) is a polycrystalline material with cubic crystal symmetry and with an average grain size of about 60 micrometer diameter. This material is optically isotropic on a macroscopic level. In one embodiment, this material is used as a substrate to manufacture cutting lenses for CO₂ lasers. Due to its very high purity, the material will only absorb a fraction of the incident laser light, which for all practical purposes is negligible. In this embodiment, the overall lens absorption (e.g., 0.30%) is dominated by the contribution of the anti-reflex coatings, which overwhelms the absorption of the ZnSe substrate. Due to the large powers available from high power CO₂ lasers, even this minor overall absorption has noticeable consequences on the lens performance in terms of focusability of the laser radiation.

There are two predominant thermal effects occurring in the body of a lens which both influence the focusability of the beam and therefore the laser beam quality, thermal lensing and stress birefringence.

Thermal lensing is the change of the effective focal length of the lens resulting from the heat generated by absorption. This extra lensing is created by temperature gradients between the lens center and the lens edge. The temperature gradients affect the local refractive index of the lens material through the thermo-optic effect which occurs in the lens body material. This results in an extra bending of the light rays.

Stress birefringence, is created by the non-uniform thermal dilatation of the lens body. The non-uniformity is imposed by the shape of the intensity distribution in the incident laser beam. This shape is normally close to Gaussian, which means a high intensity in the center of the beam, falling off gradually to zero towards the outer edge of the beam. As a consequence, the lens is heated more in the center than at its edge. Moreover, this edge is in thermal contact with a cooled heat sink, so that there is a definite radial variation in thermal expansion from the center to the edge of the lens. At the center of the lens, the absorbed heat expands the lens material and at the cooled edge, the material is not willing to expand. In this way, considerable radially oriented stresses get generated between the center and the edge of the lens. In a pictorial way, the cold lens edge is clamping the hot, expanded lens center. At this place, the elasto-optic effect becomes important. The thermal stresses change the local refractive index of the lens material. The polarization state of the incoming light will now be affected. If the polarization direction of the light is along the stress direction of the body material, the polarization state will not be changed. If the polarization direction of the light is perpendicular to the stress direction of the body material, the polarization state will not be transmitted. The behavior is similar to the situation where a linearly polarized beam is incident on two polarizers in series. If the polarizers are placed with their polarization axes parallel, the light will be transmitted. If the axes are perpendicular however, no light gets transmitted. Since the stress pattern in a heated lens can be quite complicated, the polarization state of the transmitted wave front can be heavily affected. This can mean that an initially plane polarized laser beam, will loose its plane polarization state after transmission, leading to a loss in focusability of the converging laser beam.

In summary, the refractive index distribution of the lens material is changed in two distinct ways due to thermal effects. The first is the change of the refractive index induced by the increased temperature. This effect is closely related to the mirage effect occurring in strongly heated air layers and is there known under the name “fata morgana.” The effect is called thermal lensing. The second effect is the change of the refractive index induced by thermal stresses. It is called stress birefringence or alternatively the elasto-optic effect.

Since both effects simultaneously change the local refractive index and hence the optical path length through the lens, thermal aberrations are induced which deform heavily an incoming spherical wave front upon transmission through the aberrating lens medium. Any deviation from sphericity will adversely influence the capability of the wave front to converge to its diffraction limited focused spot size. This means a loss of concentration of the laser energy at the work piece surface and hence a decrease in cutting speed.

In some embodiment, the implementation of rad pol diminishes both thermal lensing and stress birefringence. Thermal lensing and the elasto-optic effect, also called elasto-opto stress, occur superposed on each other and are directly related, although not proportionally, with increasing laser power. Since rad pol automatically implies the appearance of a ring mode, the temperature distribution in the lens will be more uniform than with a Gaussian mode, thereby reducing thermal lensing. Further, as the generated stresses are also radial, the photo-elastic is less pronounced. Both negative effects can be diminished by implementing rad pol. Further, it is surprising that the rad pol ring mode is capable of focusing down to a sharper focal point than the lin pol Gaussian or the lin pol ring mode. It is thus possible to reduce the detrimental effects of thermal lensing and stress birefringence and to focus the cutting tool down to a sharper focal point through the implementation of the rad pol ring mode as opposed to the lin pol Gaussian mode or the lin pol ring mode.

In some embodiments, the lens temperature and/or the temperature gradients are minimized.

A first solution is found in EP 0365511 which discloses a process of cooling a lens by a turbulent gas film for reducing the thermal effect by decreasing the heat absorption by the lens. This process is based on a conductive heat transfer from the lens surface to the gas film. A second solution is found in U.S. Pat. No. 6,020,992, herein incorporated by reference in its entirety, describing the use of low absorption antireflex-coatings for reducing the thermal effect by diminishing the absorption of the heat in the lens. A third solution is found in EP1380870, herein incorporated by reference in its entirety, describing a lens with improved heat transfer properties by providing a flat flange to the lens edge. Hence, the thermal contact between the lens and its water cooled support mount is improved and the lens temperature is reduced.

A fourth solution is found in U.S. Pat. No. 6,603,601, herein incorporated by reference in its entirety, disclosing an infrared laser optical element in which a dense optical thin film with a low laser absorption and high moisture resistance is formed on the surface thereof. The optical element comprises a smoothed main surface, a BaF₂ film formed on the main surface and then a ZnSe film formed on said BaF₂ film. Hence a dense film of BaF₂ can be formed and the absorption of the entire coating can be maintained to a value as low as 0.15% at most as the optical element. Unfortunately, the aforementioned solutions all present the disadvantage of providing complex lenses or complex processes which increase the cost of the high power laser cutting machine operation. For example, some aforementioned solutions are based on very low absorption coatings which present the disadvantages to rely on difficult and critical process wherein the yield is generally reduced. Hence, the cost of the high power laser cutting machine operation is increased.

In one embodiment, ZnSe lens focalization can also be used for very high power CO₂ laser beams, preventing the aforementioned thermal effect problems by applying the features of the present invention, even at laser beam powers above 6 kW and/or even with standard ZnSe lens systems (i.e. lenses without very low anti-reflex coatings and/or without sophisticated cooling provisions).

In one embodiment, a laser cutting method is employed using CO₂ laser light beam focalized by means of a ZnSe-lens system. In one aspect of the embodiment, the laser light is “radially polarized laser light”.

The terms “radially polarized laser light” or “radial polarization”, are defined as either radially or azimuthally polarized laser light or radial or azimuthal polarization, respectively. In some embodiments, both azimuthal and radial polarization are obtained by a proper superposition of two perpendicular polarized laser beams. The azimuthal polarization can be transformed to radial polarization by means of an optical element.

Radial or azimuthal polarization of laser beams is discussed in Oron et al., The Formation Of Laser Beams With Pure Azimuthal Or Radial Polarization, Applied Physics Letters, Vol. 77, 3322-3324 (November 2000), the disclosure of which is incorporated by reference in the present document. This known use of radial or azimuthal polarization of laser beams as disclosed involves a Nd:YAG (neodymium-doped yttrium aluminum garnet) laser source (involving a wavelength of 1.06 micrometer), used in the Watt-range rather than in the kilo-Watt range In some embodiments described herein, CO₂ laser sources (involving a wavelength of 10.6 micrometer) are used in the kilo-Watt range.

A laser beam with radial (or azimuthal) polarization shows a ring shaped intensity distribution. As a consequence, the heat generated in the lens will also show a ring shape. If the Fourier heat conduction equation is solved with this ring shaped heat distribution as boundary condition, it is found that the resulting temperature distribution shows a nearly top hat distribution. So globally speaking, the lens will heat up, but in a nearly uniform way. Since temperature gradients are diminished in this way, the lens will also show less thermal effect compared to the case where it is irradiated by the same power, with a linear or circular polarization state (in a Gaussian intensity distribution).

In some embodiments, radial polarization provides the same range as the focal spot of a Gaussian beam, making the ring mode suitable for cutting applications. The vector diffraction theory of Richards and Wolf has been applied on focusing a radially polarized beam. See Dorn et al., Sharper Focus for a Radially Polarized Light beam, Phys. Rev. Letters 91, 2333901 (2003), herein incorporated by reference in its entirety. If sharp focusing is realized, then, to the extent it can dominate over the transverse component, the longitudinal component of the electric field gets a macroscopic size in the focal plane. In non-vector focusing theories, this longitudinal component is never considered at shorter focal lengths, correlating to sharper focussing, the longitudinal component becomes more pronounced. The focal spot for the radially polarized field is smaller than that for the linearly polarized field. The radially polarized ring mode focuses to a smaller focal spot than the linearly polarized ring mode. In this way, it is possible to get in the same range as the focal spot of a Gaussian beam, making the ring mode suitable for cutting applications under conditions of radial polarization.

Specifically, the thermal effect is thermal lensing and stress birefringence. As those thermal effects are the most important thermal effects present in a cutting lens, it is particularly advantageous to reduce specifically the thermal lensing and the stress birefringence.

Usually, the intensity distribution of the incident laser beam shows rotational symmetry. A fraction of the incident power on the lens is converted to heat, due to residual absorption in the lens. This heat generates dilatation of the material. The dilatation in the center of the lens (and of the beam) is the highest, in case of a Gaussian mode, since the laser intensity shows a maximum in the middle of the beam. The tendency of the lens to expand in the middle is counteracted however by the lens edges since they stay cold. In this way, large stress differentials are generated between the center and the edge of the lens.

If the lens material also shows stress birefringence, its refractive index will be affected. This means for a beam with circular symmetry that the elasto-optic changes of the refractive index have a purely radial and a purely azimuthal component. Incident laser radiation with linear polarization, e.g. along the transverse x direction, will get influenced in a complicated way. Along the x-axis, the radial direction is perpendicular to this axis. Along the y-axis, the radial polarization is parallel to this axis. For an intermediate radial axis, one has to consider the projection of this axis along the x and y axis. This is fixed by the mathematical transformation laws to transform polar coordinates into Cartesian coordinates.

In some embodiments the birefringent material is illuminated by a beam with radial (or azimuthal) polarization. In these embodiments, the polarization direction is always parallel to one of the stress directions in the lens body.

Hence, in some embodiments, there will be no change of the polarization state after transmission through the lens. The stress birefringence has no influence on the transmitted wave front and there are no aberrations linked with the elasto-optic behavior of the lens under radial (or azimuthal) polarization.

Some embodiments display the unexpected applicability of ZnSe lenses for use in very high laser beam powers. In some aspects, these applications use radially polarized laser. The use of radially polarized laser light in such embodiments reduces, has the unexpected effect of reducing the thermal effect, specifically stress birefringence and thermal lensing. The use of radially polarized light in such aspects, has no direct link with the incidental observation that radial polarization is better absorbed (up to a factor 2) than circular polarization for the same laser power and therefore for the same cost of the laser

In some embodiments, ZnSe lenses are used. In some embodiments, the Zinc selenide materials used include, but are not limited to, chemical vapor deposited ZnSe (CVD-ZnSe) polycrystalline materials with average grain sizes of about 60 micron diameter. This makes such materials to behave as isotropic on a macroscopic level. The material is used as substrate to manufacture cutting lenses for CO₂ lasers.

Although the embodiments of the invention have been disclosed for illustrative purpose, those skilled in the art will appreciate that various modifications, additions or substitutions are possible, without departing from the scope and spirit of the invention as disclosed in the accompanying claims.

What is claimed is:

1. A laser cutting method using a CO₂ laser light beam focalized by means of a ZnSe-lens system.

2. The method of claim 1, wherein radially polarized laser light is applied.

3. The method of claim 1, wherein azimuthally polarized laser light is applied.

4. The method of claim 1, wherein a laser power between 4-6 kW is applied.

5. The method of claim 1, wherein a laser power above 6 kW is applied.

6. A laser cutting method, comprising:
focalizing a CO₂ laser light beam with a ZnSe lends; and,
cutting a material with the focalized laser light.

7. The method of claim 6, wherein radially polarized laser light is applied.

8. The method of claim 6, wherein azimuthally polarized laser light is applied.

9. The method of claim 6, wherein a laser power between 4-6 kW is applied.

10. The method of claim 6, wherein a laser power above 6 kW is applied.

11. A laser cutting tool, comprising:
a CO₂ laser; and,
a ZnSe lens configured to focalize the laser light.

12. The laser cutting tool of claim 11, wherein said laser light is radially polarized.

13. The laser cutting tool of claim 11, wherein said laser light is azimuthally polarized.

14. The laser cutting tool of claim 11, wherein the laser light power output is between 4-6 kW is applied.

15. The method of claim 11, wherein a laser power above 6 kW is applied.

16. A laser cutting tool, comprising:
a CO₂ laser; and,
means for focalizing having a ZnSe lens.

17. The laser cutting tool of claim 16, wherein said laser light is radially polarized.

18. The laser cutting tool of claim 16, wherein said laser light is azimuthally polarized.

19. The laser cutting tool of claim 16, wherein the laser light power output is between 4-6 kW is applied.

20. The method of claim 16, wherein a laser power above 6 kW is applied.
